(19) United States
(12) Patent Application Publication
(10) Pub. No.: US 2019/0244534 A1
(43) Pub. Date: Aug. 8, 2019

(54) Device and Process for Instructing Children in Goals and Success

(71) Applicants: Andrew Cotton, Rancho Mission Viejo, CA (US); Catherine Dumbravo, Rancho Mission Viejo, CA (US)

(72) Inventors: Andrew Cotton, Rancho Mission Viejo, CA (US); Catherine Dumbravo, Rancho Mission Viejo, CA (US)

(21) Appl. No.: 16/263,811

(22) Filed: Jan. 31, 2019

Related U.S. Application Data
(60) Provisional application No. 62/628,052, filed on Feb. 8, 2018.

(51) Int. Cl. G09B 1/06; G09B 1/20; G09B 19/00

(52) U.S. Cl. CPC G09B 1/06; G09B 19/00; G09B 1/20

(57) ABSTRACT

The device is a stylized board to monitor and reward children's educational and behavioral goals. The board comprises a flat surface with raised up, moving parts, where some laterally moving parts are used to track the completion or failure to complete daily goals, and the other moving parts revolve to eventually reveal a hidden image when the child achieves a particularly noteworthy success.

### CROSS-REFERENCE

Applicants claim priority of a provisional application, No. 62/628,052, filed Feb. 8, 2018.

We, Andrew Cotton and Catherine Dumbravo of Rancho Mission Viejo, Calif., have invented a device and process for tracking children's education and behavior as well as creating incentives for the children to reach their daily goals and long term successes. The device is a stylized board that will have moving parts on separate tracks, where some parts can be moved laterally, forward and backward during a day in a life of a child, as symbols for rewards or criticisms regarding certain behaviors. Some other parts can be revolved on an axle to eventually reveal a hidden image that indicates a larger reward is due for outstanding achievement. The process is the means for moving the parts on the board, either forward or backward on a track or on the revolving axle, to monitor and reward the child's activities and behaviors.

### STATEMENT REGARDING FEDERAL SPONSORED RESEARCH

None.

### PARTIES TO JOINT RESEARCH AGREEMENT

None.

### FIELD OF THE INVENTION

The board is stylized with a theme depending on the targeted demographic. For instance, in one embodiment, the theme relates to characters in a garden inhabited by a Royal Bee and Worker Bees as depicted in the accompanying drawings. In another embodiment, the characters are located at sea with roving pirates and sailors. In another embodiment, the characters are located in outer space with floating astronauts. And in another embodiment, the characters are located in Medieval Times with knights and princesses. Other embodiments can also be implemented on the stylized board.

Each theme depicts the same two principal characters, Phil, a fox, and Sophia, a rabbit, but in different settings. There are four sections on each stylized board identified as “Opportunities,” “Choices,” “Long Term Successes,” and “Daily Goals.” The “Opportunities” section is used to monitor and reward performance of a set of ten acts identified as: “Mornings,” “Listen,” “Eat,” “Punctual,” “Manners,” “Respect,” “Grateful,” “Learn,” “Clean,” and “Bedtime.” Upon performance of each of the ten acts during a given day in the life of a child, a raised piece is moved laterally from left to right, across a track in the “Choices” section, by the child's parent to record performance of the act. Provided that if a child errs, even after completing one of the ten acts, then the raised piece is moved backward, from left to right. The child's goal is also to complete at least eight of the ten acts where the piece has been moved to the right side of the track on a given day. At the end of the day, the pieces are reset and moved back to the left side of the track. When the child meets his or her goal in a given day, then in the “Long Term Success” section of the board one of seven pieces mounted on axles is revolved to reveal part of a hidden picture, where the hidden picture is part of the theme. After seven days of successfully completing the performance acts, meaning performance of at least eight of the acts, then the entire hidden picture is revealed. The revealing of the entire hidden picture justifies giving the child a reward. After the hidden picture is revealed, the pieces are reset to again conceal the hidden picture.

In the “Daily Goals” section, an outstanding act by a child is recorded by moving a special piece laterally from right to left across a track, entitling the child to an even more significant reward. After the reward is given, the piece is reset to the left side of the track.

### BACKGROUND OF THE INVENTION

The present method of pre-school children's behavior tracking, is very simplistic typically involving boards that permit the use of erasable markers, stickers, or magnets to record a child's performance. The purpose of tracking performance is to allow a parent to recall what the child has accomplished during the day and then display performance to the child so that he or she can achieve a level of satisfaction.

In the current state of the art, the typical boards only track whether tasks have been completed and allow either a designation of rewardable or punishable behavior. The prior art does not have a story telling element that is present in this invention. Here the child has an incentive to see the progress of the story developing on the board as he or she performs the identified acts.

The stylized board, known as “Better me Boards”™ can either be kept on a flat surface or it can be hung on a wall. The stylized board includes a front and a back. The front part of the stylized board is used to track performance of educational goals, completion of chores, good behaviors, or a combination of the foregoing. The back of the board contains the rules and instructions for engaging in the process.

The stylized board's display is three dimensional. The front of the board has an artistic design which is presents a story line. There are moving parts or characters that are placed on either a track for lateral movement or are placed on an axle for revolving movement.

### BRIEF DESCRIPTION OF THE DRAWINGS

FIG. 1 is a planar image of the front side of the board.

FIG. 2 is a planar image of the back side of the board.

FIG. 3 is a detail view of raised and movable pieces on separate tracks.

FIG. 4 is a detail view of rotatable panels on separate axles.

FIG. 5 is an exploded view of the ten raised pieces which are moved laterally on a track to record performance of one of the ten acts and an additional raised piece which can be moved on a separate track.

FIG. 6 contains two views, where FIG. 6A is a front, prospective view of the seven pieces which are rotatably moved on an axle to record performance of at least eight of the ten acts in a given day, and FIG. 6B is a back, prospective view of the same seven pieces.

FIG. 7 is a front view showing a laminated character affixed to a base.

### DETAILED DESCRIPTION OF THE INVENTION

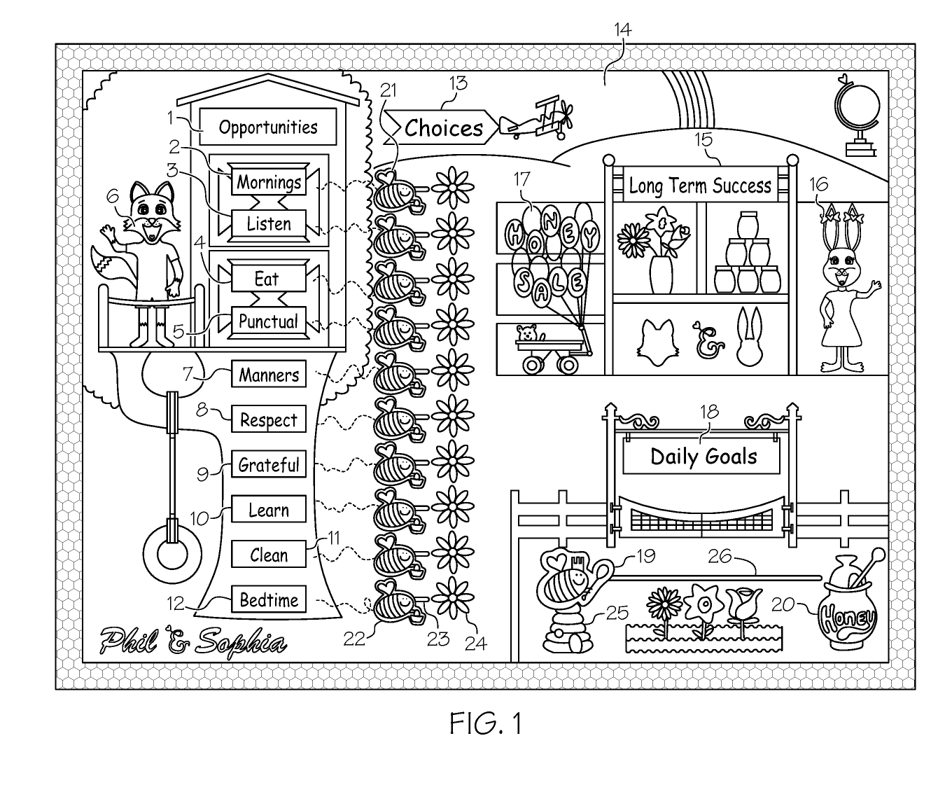

Applicants' device contains a stylized board 14 on FIG. 1, with artwork depicting a story involving two characters, “Phil and Sophia,”© a fox and rabbit. The characters engage in a variety of adventures, and the stylized boards 14 is designed with different adventures depending on the targeted demographic. In FIG. 1, the depicted setting contains a tree and a flower bed in a garden.

From FIG. 1, the device for instructing children in moral values and recording progress, comprises: A stylized, rectangular board 14 with a daily story told by two principal characters, a fox 6 and a rabbit 16. There are four sections, designated as “Opportunities 1,” “Daily Goals 18,” “Choices 13,” and “Long Term Successes 15.” The “Opportunities 1” section contains a columnar listing of ten acts identified as follows: “Mornings 2,” “Listen 3,” “Eat 4,” “Punctual 5,” “Manners 7,” “Respect 8,” “Grateful 9,” “Learn 10,” “Clean 11,” and “Bedtime 12.” Performance by a child of each of the ten acts is recorded in the “Choices 13” section each day by the child's parent laterally moving one in a series of ten raised, slidably connected markers 21 corresponding to each of the ten acts in the “Opportunities 1” section, from a first position of rest on a left side 22 of a path 23, to a second position of rest on a right side 24 of the path 22. A mistake related to one or more of the ten acts committed by the child results in the child's parent moving the corresponding marker from the second position of rest on the right side 24 of the path back to the first position of rest on the left side 22 of the path 23 in the “Choices 13” section.

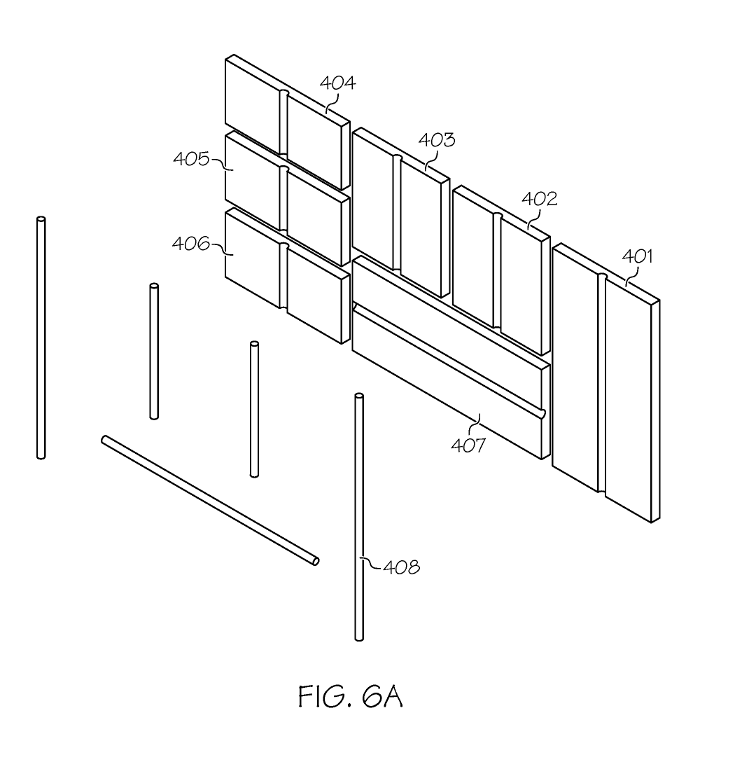

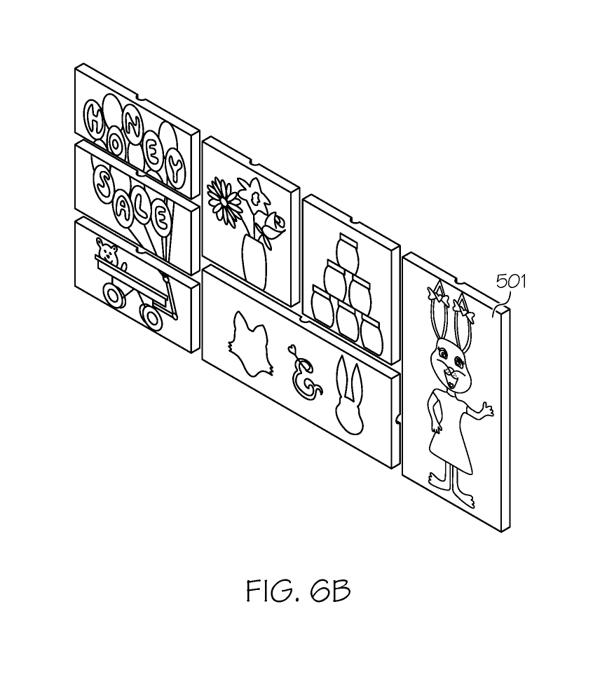

The “Long Term Success 15” section contains a hidden image 17 under seven rotatably connected panels. At the end of each calendar day, where at least eight of the ten raised, slidably connected markers 21 is in the second position of rest on the right side 24 of the path 23 in the “Choices 13” section then the child has achieved a success, and one of the seven rotatably connected panels for instance 402 on FIG. 6A is revolved, partially revealing the hidden image 17 on FIG. 1 in the “Long Term Successes 15” section. Following seven days where the child achieves at least the same success in performing at least eight of the ten acts in the “Opportunities 1” section then the entire hidden image in the “Long Term Success 15” section is revealed, 501 at FIG. 6B. The ten raised, slidably connected markers 21 are re-set to the first position of rest 22 at the end of each calendar day. After the hidden image in the “Long Term Successes 15” section is completely revealed, then the seven rotatably connected panels FIG. 6A at 402 to 408 are revolved to again conceal the image.

The “Daily Goals 18” section is used to reward the child's performance of a significantly creative act unrelated to the ten acts in the “Opportunities 1” section, by the child's parent laterally moving a raised character 19 from a first position of rest 25, across a track 26 to a second position of rest 20. After the child is rewarded in the “Daily Goals” section, the character 19 is moved back from the second position of rest 20, across the track 26 to the first position of rest 25.

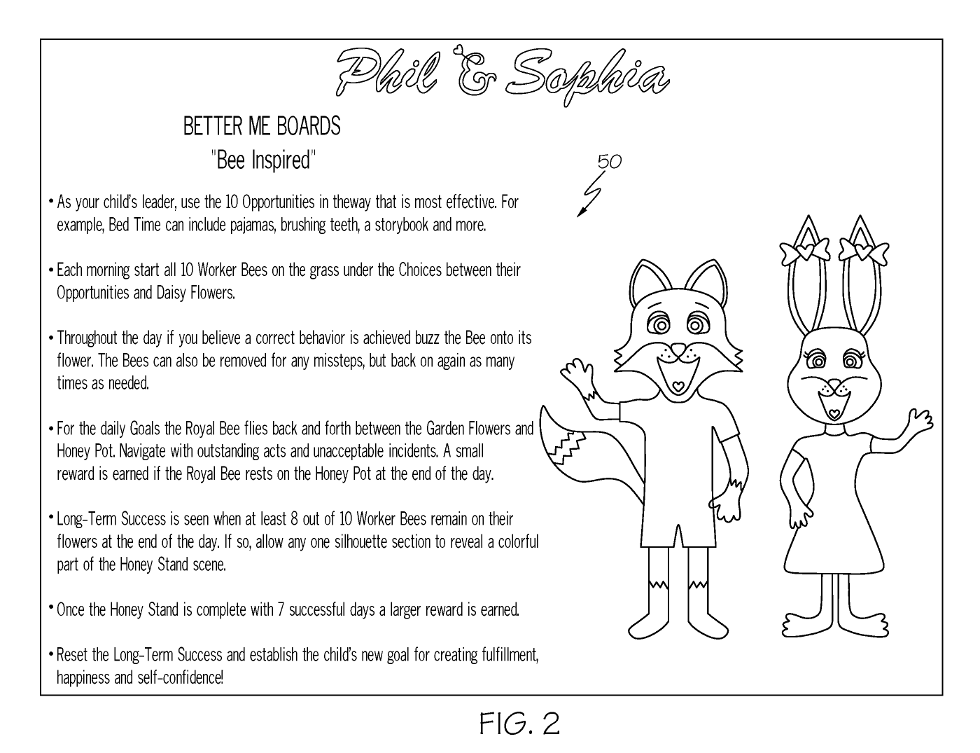

In FIG. 2 at 50 the rules for performing and recording the child's performance are displayed.

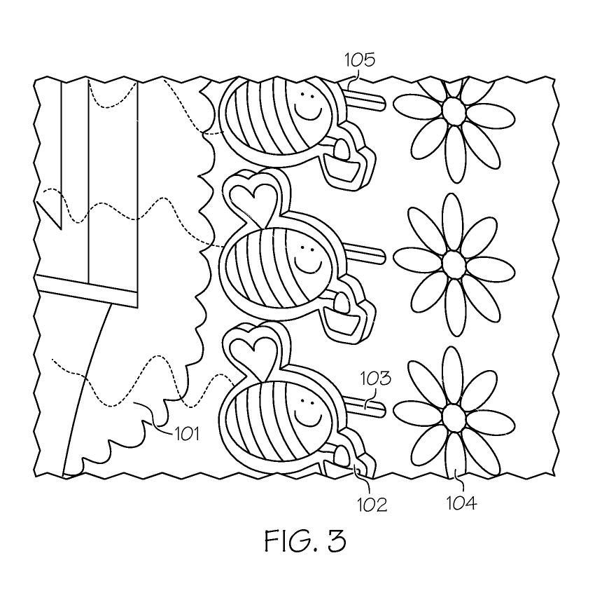

In FIG. 3 the raised movable pieces in the “Choices” section are shown, there are ten raised, slidably connected markers 102 corresponding to each of the ten acts in the “Opportunities” section. The raised, slidably connected markers 102 are located proximal to a tree 101 in a garden. The raised, slidably connected markers 102 can be laterally moved on a track 103 from a first position of rest 105 to a second position of rest on a flower 104.

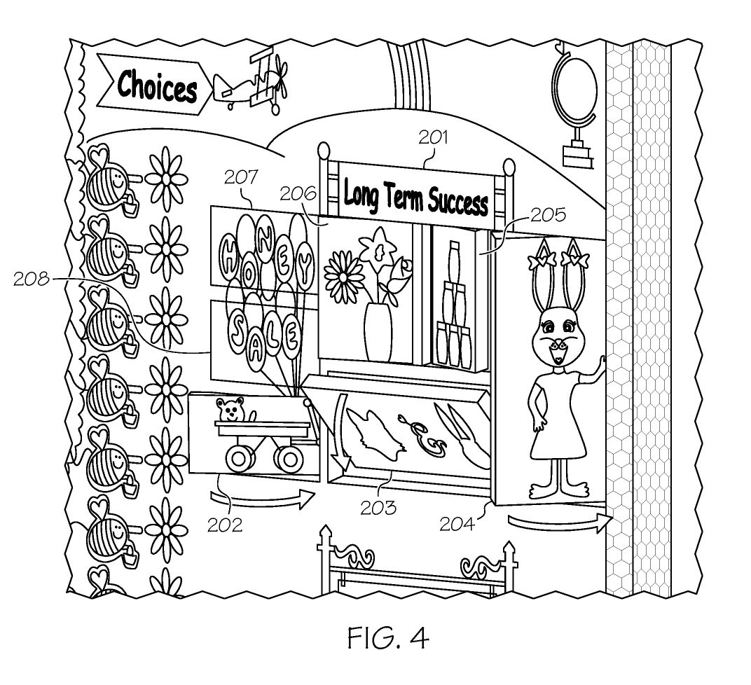

in FIG. 4 the seven rotatably connected panels in the “Long Term Successes 201” section are rotated each day where the child achieves a success as recorded in the “Choices” section by having at least eight of the ten raised, slidably connected markers moved to the right side of the track at the end of a given day. One revolvable panel for instance, 202 is turned 180 degrees, to reveal a portion of a hidden image on a first day where success is achieved by the child. An adjoining revolvable panel for instance 203 is turned 180 degrees, to reveal another portion of a hidden image on a second day where success is achieved by the child. And the process continues on a third day where another revolvable panel 204 is turned, on a fourth day where another revolvable panel 205 is turned, on a fifth day where another revolvable panel 206 is turned, on a sixth day where another revolvable panel 207 is turned, and on a seventh day where a last revolvable panel 208 is turned.

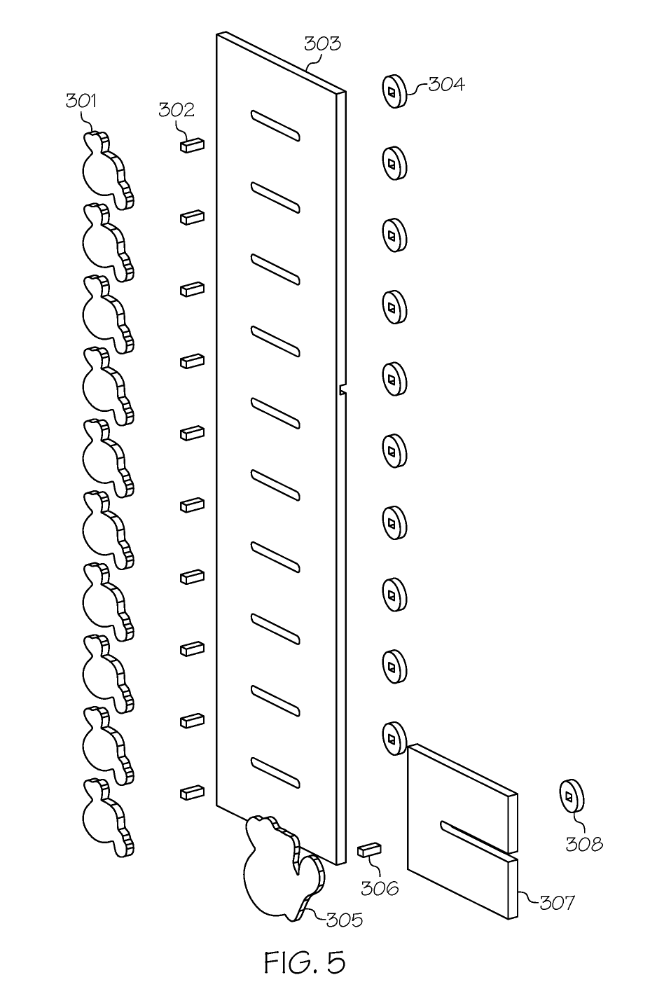

In FIG. 5, an exploded view of the components of the ten raised, slidably connected markers 301 in the “Choices” section is shown. Each of the ten raised, slidably connected markers 301 is inserted onto a dowel 302. The dowel 302 passes through a track 303 and is held in place by a base 304. In similar fashion, the raised marker 305 in the “Daily Goals” section is inserted onto another dowel 306, which dowel passes through a track 307, and is secured in place by a base 308.

In FIG. 6A, the hidden image side of the seven rotatably connected panels 402, 403, 404, 405, 406, 407 and 408, in the “Long Term Successes 401” section is shown. The rotatably connected panels are attached to one of several axles 409. The back side of the hidden image is blank, referred to as a blank panel, on FIG. 6A. Turning a blank panel 180 degrees on one of the several axles reveals part of the hidden image. The entire hidden image 501 is shown on FIG. 6B.

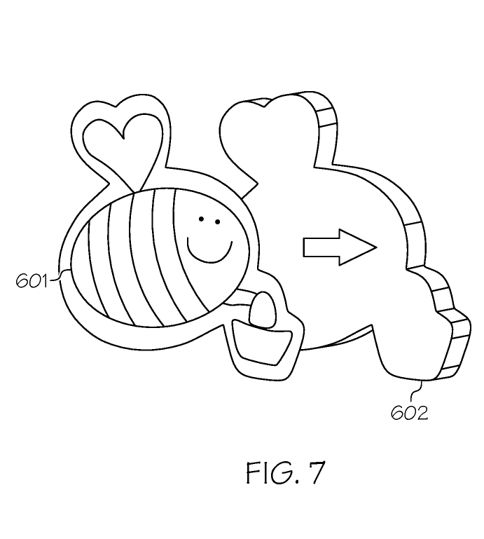

In FIG. 7, a colorized character 601 is laminated onto a cut-out 602 of the character. In the fashion of coloring or painting the characters and then placing them onto thicker and sturdier bases, the stylized board is assembled.

In one embodiment Phil and Sophia are collecting honey and then selling the collected honey on a stand. The board has a list of ten “Opportunities” identified as “Mornings,” “Listen,” “Eat,” “Punctual,” “Manners,” “Respect,” “Grateful,” “Learn,” “Clean,” and “Bedtime.” In another embodiment a parent-user can create and insert other opportunities. When the child successfully completes an “Opportunity,” there is a means for a raised worker bee in the “Choices” section to be moved laterally on a track from a grassy area to a flower. There are ten flowers and ten worker bees. There is a means for worker bees to be moved on a mechanical track. If the child has a misstep the worker bee can be moved backwards. The means for moving the worker bee include a lever connected to the track which can be operated by hand, by switch on the board activating an electric motor, or remotely activating the switch for the electric motor.

If the child completes an outstanding act for which the parent wishes to provide an additional reward, there is a section of the board entitled “Daily Goals.” In this example, the “Daily Goals” section includes an image with three garden flowers and a honey pot. There is a “Royal Bee” which represents a particularly outstanding act. There is a means for moving the “Royal Bee” over the three garden flowers, until she eventually makes it to the honey pot. There is also a means for moving the “Royal Bee” on a mechanical track. The means for moving the “Royal Bee” include a lever connected to the track which can be operated by hand, by switch on the board activating an electric motor, or remotely activating the switch for the electric motor.

There is another section on the board entitled “Long-Term Success.” There is a hidden image with revolving pieces. In this example, the hidden image is a honey stand. If eight out of the ten worker bees remain on their flowers at the end of the day, there is a means for removing one of the pieces of a hidden image to reveal part of a picture. After seven successful days, the entire honey stand image is revealed. The means for removing the pieces of the hidden image include having the removable pieces attached by Velco™ or similar fastening material to the board so as to allow for repeated or alternating removal and re-attachment.

All of the sections designated as “Opportunities,” “Daily Goals,” “Choices,” and “Long Term Successes” and the ten acts designated as “Mornings,” “Listen,” “Eat,” “Punctual,” “Manners,” “Respect,” “Grateful,” “Learn,” “Clean,” and “Bedtime” can be removed and replaced with equivalent words in Spanish. Translation to other languages is also possible.

A separate treasure chest contains prizes to reward the child's performance of a significantly creative act unrelated to the ten acts in the “Daily Goals” section.

The process of using the device, involves moving the pieces to reward or criticize the child's behavior or completion of certain goals. The pieces in the “Opportunity” and “Daily Goals” sections of the board move along a track. The pieces in the “Long Term Success” are able to revolve so as to reveal the image on the underside. The rules for the process of using the device or playing the game FIG. 2 at 50, are:
1. As your child's leader, use the 10 Opportunities in the way that is most effective. For example, Bed Time can include pajamas, brushing teeth, a storybook and more.
2. Each morning start all 10 Worker Bees on the grass under the Choices between their Opportunities and Daisy Flowers.
3. Throughout the day if you believe a correct behavior is achieved buzz the Bee onto its flower. The Bees can also be removed for any missteps, but back on again as many times as needed.
4. For the daily Goals the Royal Bee flies back and forth between the Garden Flowers and Honey Pot. Navigate with outstanding acts and unacceptable incidents. A small reward is earned if the Royal Bee rests on the Honey Pot at the end of the day.
5. Long-Term Success is seen when at least 8 out of 10 Worker Bees remain on their flowers at the end of the day. If so, allow any one silhouette section to reveal a colorful part of the Honey Stand scene.
6. Once the Honey Stand is complete with 7 successful days a larger reward is earned.
7. Reset the Long-Term Success and establish the child's new goal for creating fulfillment, happiness and self-confidence!

Various embodiments described above may be combined with each other in connection with the claimed device. Further, the order of steps in the claimed method may be changed. Other embodiments of the invention will be apparent to a person of ordinary skill in the art. It is intended that the specification and embodiments be considered as exemplary only.

We claim:

1. A device for instructing children in moral values and recording progress, comprising:
a stylized, rectangular board with four sections, designated as “Opportunities,” “Daily Goals,” “Choices,” and “Long Term Successes;”
where the “Opportunities” section contains a columnar listing of ten acts identified as: “Mornings,” “Listen,” “Eat,” “Punctual,” “Manners,” “Respect,” “Grateful,” “Learn,” “Clean,” and “Bedtime;”
where performance by a child of each of the ten acts is recorded in the “Choices” section each day by a child's parent laterally moving one in a series of ten raised, slidably connected markers corresponding to each of the ten acts from a first position of rest on a left side of a path, to a second position of rest on a right side of the path;
where a mistake related to one or more of the ten acts by the child results in the child's parent moving the corresponding marker from the second position of rest on the right side of the path back to the first position of rest on the left side of the path in the “Choices” section;
where the “Long Term Success” section contains a hidden image under seven rotatably connected panels;
at the end of each calendar day, where at least eight of the ten raised, slidably connected markers is in the second position of rest on the right side of the path in the “Choices” section then the child has achieved a “Success,” and one of the seven rotatably connected panels is removed, partially revealing the hidden image in the “Long Term Successes” section;
where following seven days where the child achieves at least the same “Success,” then the entire hidden image in the “Long Term Success” section is revealed;
where the ten raised, slidably connected markers corresponding to each of the ten acts in the “Choices” section are re-set to the first position of rest on the left side of the path, after the end of each calendar day;
where after the hidden image in the “Long Term Successes” section is completely revealed, then the seven rotatably connected panels are replaced to conceal the hidden image;
where the “Daily Goals” section is used to reward the child's performance of a significantly creative act unrelated to the ten acts, by the child's parent laterally moving a character from a first position of rest, across a track to a second position of rest;
and where after the child is rewarded in the “Daily Goals” section, the character is moved back from the second position of rest, across the track to the first position of rest.

2. The device of claim 1, where the ten acts in the “Opportunity” section can be removed and replaced with other acts selected by the parent.

3. The device of claim 1, where all of the sections designated as “Opportunities,” “Daily Goals,” “Choices,” and “Long Term Successes” and the ten acts designated as “Mornings,” “Listen,” “Eat,” “Punctual,” “Manners,” “Respect,” “Grateful,” “Learn,” “Clean,” and “Bedtime” can be removed and replaced with equivalent words in Spanish.

4. The device of claim 1, where a separate treasure chest contains prizes to reward the child's performance of a significantly creative act unrelated to the ten acts in the “Daily Goals” section.
